(19) United States
(12) Patent Application Publication
(10) Pub. No.: US 2024/0028825 A1
(43) Pub. Date: Jan. 25, 2024

(54) DEVICE FOR SYNTACTIC PARSING OF NATURAL LANGUAGE

(71) Applicants: Lowie VAN SPRANG, Tilburg (NL); Matthias DELLIT, Konstanz (DE); Evita GIARDINELLI, Montesilvano (IT)

(72) Inventors: Matthias DELLIT, Konstanz (DE); Evita GIARDINELLI, Montesilvano (IT)

(21) Appl. No.: 18/256,912

(22) PCT Filed: Dec. 9, 2020
(86) PCT No.: PCT/DE20/00329

§ 371 Date: Jun. 9, 2023

(30) Foreign Application Priority Data
Dec. 9, 2020 (DE) 2020000329

(51) Int. Cl. G06F 40/211; G06F 40/253; G06F 40/242

(52) U.S. Cl. CPC G06F 40/211; G06F 40/253; G06F 40/242

(57) ABSTRACT

An apparatus for analyzing natural language. The apparatus includes a reading in device of a computer system for reading in and providing at least one character string, a dictionary device of the computer system adapted to decompose the at least one character string provided by the reading device into a plurality of lexical elements, a syntax device of the computer system adapted to associate at least one grammatical category/syntactic element with each lexical element of the at least one character string, and a verification device of the computer system, which is designed to automatically determine, for syntactic elements in a frame with a predetermined number of lexical elements of the at least one character string, which of the arrangements of the syntactic elements in the frame are correct and which are incorrect on the basis of grammar/syntax patterns of a natural language for grammatical categories of the lexical elements.

### TECHNICAL FIELD

The present invention relates to a Device for syntactic parsing of natural language

### BACKGROUND

When processing natural language by machines, such as in the context of automatic translation programs or interpretation of commands in the man-machine interface, computer-related devices and procedures repeatedly encounter difficulties, since certain topics can only be determined from the meaning of the sentence, which in turn can only be determined precisely, if the syntactic information of each word is known: such as part of speech (noun, verb, pronoun, adjective), with grammatical case, genus, numerus, resp. tense (e.g. present, past) or person (e.g. first person singular, third person plural), which are intuitively known to a natural speaker of the language, but—until now—there are no known machine procedures which can automatically determine the syntax of a sentence consistently, completely, precisely and quickly.

### SUMMARY

An apparatus for analyzing natural language in the form of at least one character string. The apparatus may include a reading device of a computer system for reading and providing the at least one character string, a dictionary device of the computer system configured to decompose the at least one character string provided by the reading device into a plurality of syntactic elements, a syntax device of the computer system configured to assign at least one grammatical category to each lexical item, and a verification device of the computer system, configured to automatically determine, for syntactic elements in a frame with a predetermined number of lexical elements of the at least one character string, which of the arrangements of the lexical elements in the frame is correct and which is incorrect on the basis of grammar or syntax patterns of the natural language stored in advance in a database for grammatical categories of the lexical elements. The apparatus may also include a correction and completion device configured to determine, in the at least one character string and grammatical categories associated with the lexical elements, systematical changes in at least one lexical element of the at least one character string, or by adding lexical elements with suitable grammatical categories, that the verification device recognizes the at least one character string, after the at least one introduced change in the at least one character string, as correct by renewed pattern matching.

### BRIEF DESCRIPTION OF THE DRAWINGS

The invention is explained with reference to examples of embodiments and with reference to figures. Thereby showing:

FIG. 1 a first example sentence explaining how a string can be decomposed into syntactic elements and how a grammatical category can be assigned to the lexical elements;

FIG. 2 the character string according to FIG. 1 during a processing step (in the example step 6 after the first comma) to determine possible grammatical categories;

FIG. 3 the character string according to FIGS. 1 and 2 after completion of the comparison;

FIG. 4 a schematic representation of a computer system with an embodiment of the device.

### DETAILED DESCRIPTION

Known syntactic parsing methods usually use statistical methods and parsing trees. However, since natural language is—not—statistically processed by the brain in its cognitive basis, these methods fail, when there are higher demands on detection of grammatical errors and fineness of syntactic resolution of the parsing. The precise determination of logical and semantic relations, actors, proper names, etc., of words in the overall context is limited by state-of-the-art methods, which in turn unnecessarily complicates speech AI applications, and so far severely restricts the comprehensive processing of knowledge in unstructured texts/statements, or, due to lack of traceability, prevents the application of language/voice AI in applications with mission critical safety requirements of the human-machine interface.

Since words in part have a very high variety of syntactic forms—e.g. every German adjective usually has 147 different syntactic forms, if declension strength, grammatical case, gender and comparative are considered—it is common that already normal sentences have millions to billions of theoretical possible syntactic assignment combinations, with the result of very large computation times, if one wants to achieve high determination accuracy without using the imprecise, statistical state of the art. Thus, if one wants to use more precise methods than statistics for parsing, the problem of computation times must be solved at the same time.

Therefore, the task persists, to develop devices and methods that allow the syntax of a string of natural language to be determined automatically with a much higher degree of accuracy, with simultaneously short process times in the 1 second range, on standard computers/smartphones, than so far the state of the art allows it.

These tasks are solved by a device having the features of claim 1.

The apparatus comprises a reading device for reading in and providing at least one character string. Further, the apparatus comprises a dictionary device, which is designed to convert at least one character string provided by the reading device into automatically processable, numerically categorizable, syntactic and lexical elements of the presented text.

For this purpose, the device has a syntax device designed to assign to each syntactic and lexical element in its basic form at least one of its numerically processable grammatical categories of the language, which usually consist of more than a single possibility. E.g., in German there are massive declension-related variants to be considered: wine: the wine, for the wine, of the wine, at the wine, the wines, of the wines, at the vines; In English, on the other hand, often several different categories per word: e.g. “round”=noun, adjective, verb, adverb.

The end result is, to identify the root/base form of each lexical item/word and for this to automatically determine the grammatical category that each word actually carries in the analyzed sentence.

### Example 1: Annotated is the Only Syntax Solution for the Input Sentence

“Komplexen Weinen werden oft Barriquearomen zugesetzt.”
“To Complex wines, barrique aromas are often added.”

| | |
|---|---|
| Input¹ | : Komplexen \| Weinen \| werden \| oft \| Barriquearomen \| zugesetzt. |
| | to complex\| wines \| are often \| barrique aromas \| added |
| Basic form: | komplex \| Wein \| werden \| oft \| Barriquearoma \| zusetzen |
| part of speech: | Adj \| Subst \| Verb \| Adv \| Subst \| Verb |
| Numerus: | Plural \| Plural \| Plural \| \| Plural \| |
| Inflection: | strong \| \| \| \| \| |
| Gender: | mask \| mask \| \| \| neut \| |
| Gr. case: | dative \| dative \| \| \| nominative \| |
| Conjugation: | \| 3rd pers \| \| \| Partiz.perf |

ΣVar per cat: 26 | 8 | 4 | 1 | 8 |5
Π all cat variants = 26*8*4*1*8*5 = 33,280
E.g. here solved technical task: find the only correct solution in the 33,280 possibilities.
(At 1/100 second computation time per variant, a machine that does not use the
invention, and does not work statistically, will take about 5 minutes).

Note that the detail content of the example 1 is left in German, because a translation would completely change the content of the table (number of variants, gender, grammatical case, etc.). When viewed holistically, this simple sentence already has a total of 26*8*4*1*8*5=33,280 theoretical possible combinations of grammatical categories, which its lexical elements can each theoretically take separately, in the form of the input.

The claimed apparatus includes a verification device, which is designed to automatically determine, for grammatical/syntactical elements, the at least one character string, on the basis of natural language grammatical/syntactical patterns stored in advance in a database, for grammatical categories and basic forms of lexical elements, in a few 1/10-seconds on a commercially available portable computer/smartphone, which one, of the e.g. more than 33-thousand possible selection sequences of grammatical/syntactical categories in the sentence here, is the only correct.

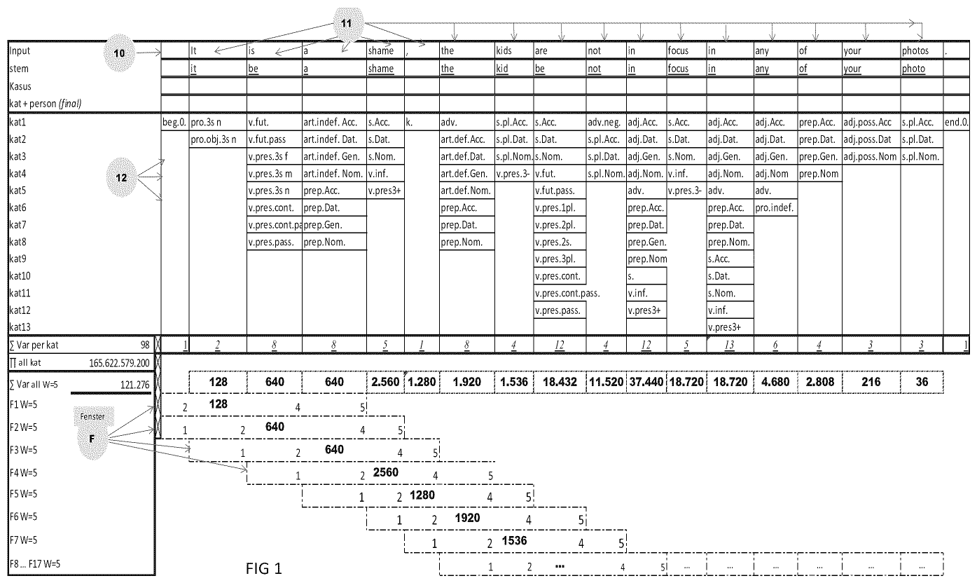

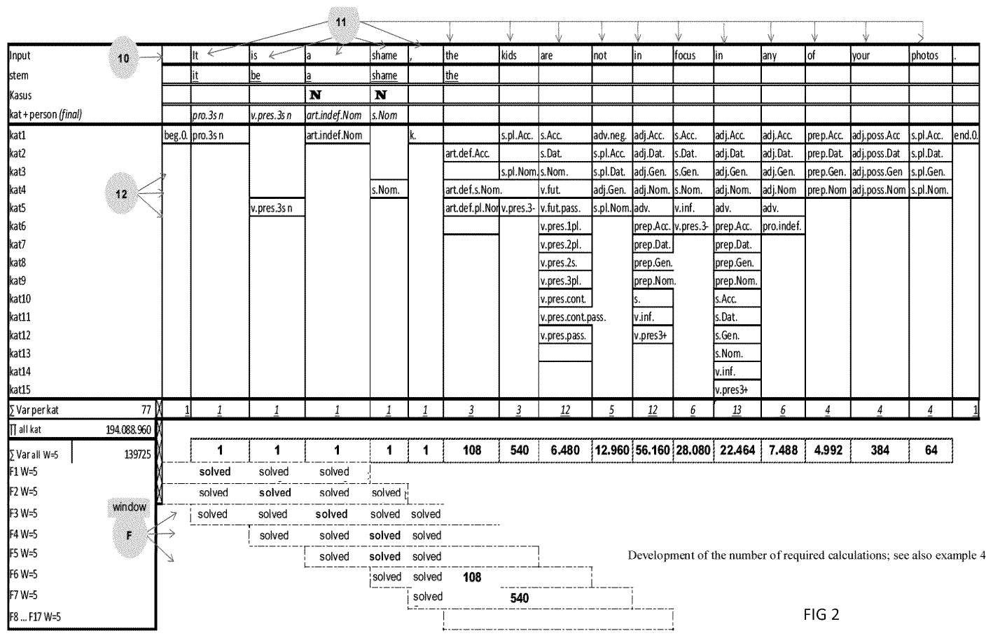

The examination of a character string can take place efficiently, with systematic processing of several consecutive, e.g. 5 words/lexical elements at the same time, and repeatedly moved on, word for word in natural reading direction. So to speak via a virtual “sliding window” F with the width “W”, (see also FIGS. 1 and 2) similar to the
“shifting eye-fixation window”
   when a human reads a text. It is efficient, but not a requirement, to change the position by the value +1 from step to step, but all positions must be taken at least once during the procedure, unless for words with only one grammatical category.

The combination possibilities of the possible grammatical categories of the several, consecutively, simultaneously acquired words are processed as a field (see also FIGS. 1 and 2), and the combinatorial single results of each field are compared with all other fields of all other columns of the reduced field or matrix, with grammar/syntax patterns of the language retrievable in a memory, which are coupled with the basic forms of the lexical items.

False combinations are removed from the matrix in their respective assigned column for each step. True ones are kept. For false ones, the corresponding categories are removed for each word, which in addition quickly thins out the solution field. The procedure is repeated sequentially, word by word, until only 1 single category remains for each word. This is the case with correctly formulated sentences and a sufficiently high, coherent number of available grammar/syntax patterns. High-level languages are well covered with approx. 4000-to-10,000 true or false grammar/syntax patterns, depending on the language use (simple, with short sentences <13 words-to-highly scientific/artistic/figurative). With syntactically incorrectly formulated sentences, or syntactically non-univocal (ambiguous) sentences (see example 3.), at least 1 word of the sentence is left, containing more than one single grammatical/syntactic element for one of the lexical elements. If more than 1 category remains for a lexical item in a processing pass, the process is repeated until the number of assigned categories after a pass does not change relative to the number of categories when it started.

Grammar/syntax patterns can take the following forms.

### Example 2. Typical Sequential Lexically Represented Grammar/Syntax Patterns of a Language with Numerus Inflectional Articles+Nouns, Pronouns, with True/False Patterns

...

| | |
|---|---|
| \| article \| object pronoun \| noun \| = wrong | (pattern length=3) |
| \| article.singular \| noun.singular \| = correct | (pattern length =2) |
| \| article.singular \| noun.plural \| = false | (pattern length =2) |
| \| Personal Pronoun \| Verb Conjugated \| Object- | (pattern length =4) |
| Pronoun.Dat \| Verb.inf \| = correct | |
| \| Object-Pronoun.Dat \| Verb Conjugated \| | (pattern length =4) |
| Personal Pronoun \| Verb.inf \| = false | |

...

These patterns can be efficiently extracted from the possibilities that have correct sentences: In the example of FIG. 1, for the lexical item “it”, “False” patterns in English are e.g..
   |pro.obj 3s n|v.pres.3s. f|=False
   |pro.obj.3s n|v.pres.3s. m|=False
   |beg.0.|pro.obj.3s n|=False

For the second lexical item “is”, “False patterns” are e.g.
   |v.pres.cont.|art.|v.inf.|=False
   |v.pres.cont.|prep.|s.Nom|=False

In this way, for any language, after manual processing of about 5000 different—grammatically correct sentences of sufficiently high morphological variance, one can obtain the true/false grammar/syntax patterns required for using the method.

It is to be considered that only with true-patterns a function of the procedure cannot be produced in simpler way, than as with the combination of true and false.

The only remaining variant does not necessarily have to be a “true” pattern, but at least not a “false”.

It must be taken into account that this manual work of pattern selection is carried out exclusively with 100% correct sentences in terms of punctuation, spelling and syntax. Otherwise, no coherent overall system of grammar/syntax patterns will be created.

Special features of languages, such as the collocation of verb particles of compound verbs in German, can also be successfully solved with the procedure, since the patterns of occurrence, e.g. of verb particles, happen at places where prepositions give a false pattern and can be matched with the system dictionary.

The presented solution principle is suitable for every language, which shows repeating grammar/syntax patterns when speaking, or writing. No matter whether natural language or not. The characters or signals referred to, can be arbitrary. (also Morse code, flag guidance as used by a flag semaphore, etc.). Pattern lengths (pattern-category sequences) of usually 2-5 words/lexical units are sufficient, corresponding to the eye-fixation window when visually interpreting messages, or corresponding to approx. 15-20 “lexical single signals” per second, when listening to acoustic sequences. But there is no limitation for the considered pattern lengths by the procedure itself.

As lexical elements, punctuation marks, or beginning and end of sentences can also be included in the grammar/syntax patterns. If necessary, in continuous text, lexical elements and their grammatical/syntactic information of sentences before or after the analyzed can be taken into account. E.g. in case of interrogative or interjective character strings. In particular, the beginning of the at least one string and the end of the at least one string, or commas, dashes, etc., in the string may each represent a lexical element. Punctuation marks, such as semicolons or colons, can usually be treated like sentence beginnings for syntax, in the reading direction. This means that the punctuation of sentences can also be captured by patterns with the method, and can therefore be checked and corrected very efficiently without having to establish classic grammatical rules according to a grammar textbook. The same applies to capitalization patterns of text by upper and lower case letters.

The procedure is therefore also suitable for the analysis of spoken strings (lexicalized phoneme strings from “Voice To Text” machines), which are created neither with punctuation marks nor with upper and lower case letters while speaking.

In a further embodiment of the apparatus, a verification device is designed in such a way that correct grammatical categories of the lexical elements determined frame by frame (frame F with width W) are identified.

If an analysis run with the device does not result in an unambiguous solution, but on the other hand, for example, in the case of automatic insertion of additional commas, or capitalization at certain places in the sentence, then an automatic comma setting, or spelling correction can be carried out with it via a correction and completion device.

In such cases, parallel processing of alternative spellings of the at least one character string can be performed in the machine simultaneously, to save time.

Accordingly, in a further embodiment, syntactic errors in the at least one character string are detectable with the verification device, wherein a syntactic error is present, if the verification device, after completion of the analysis of all possible combinations, has detected more than one single permitted grammatical category for at least one lexical element.

It is also possible that the verification device, validates the at least one character string as syntactically correct and unambiguous, if exactly one permitted grammatical category can be determined for each lexical element.

It is also possible for the correctness of each lexical item to be verifiable by checking each syntactic item against a dictionary of the dictionary device.

In one embodiment, the device may comprise a correction device for automatically correcting syntactic errors in the at least one character string.

First, the basic function of one embodiment will be explained by analyzing a character string 10.

FIG. 1 shows the sentence “It is a shame, the kids are not in focus in any of your photos” (in German: “Es ist schade, dass die Kinder auf keinem deiner Fotos scharf abgebildet rind.”) in the form of a string 10. For the sake of clarity, the procedure is described here using only one sentence as string 10. In principle, more than one sentence, i.e. longer text, can also be examined.

The character string 10 in FIG. 1 is borrowed from the English language, although for the embodiments described below it is in principle not important which language the character string 10 is taken from. All that matters is that the natural language has certain coherent grammatical structures that can be found in all correctly spelled words and punctuation marks (collectively referred to here as lexical items 11) in a syntax-dependent manner that can be assigned to certain grammatical categories 12 in a repeatable manner. In the right column of the following table some possible examples of grammatical categories 12 of the German language are given. Note that the list contains grammatical categories which do not necessarily exist in classical teaching grammar, but which may be indispensable for an informatic-stringent logic structure of a machine.

TABLE 1
Examples of grammatical categories of the German language

| | |
|---|---|
| Noun (s.) | Standard (s.), proper noun (pn.) |
| Verb (v.) | Infinitive (inf.), past participle (pper.), present participle (ppres.), . . . |
| Adjective (adj.) | Comparative (comp.), superlative (supr.), possessive (pos.), number (num.) |
| Article (art.) | Definite (def.), indefinite (indef.) |
| Conjunction (conj.) | Copulative (copu.), disjunctive (disj.), . . . |
| Adverb (adv.) | Time (_tim), Place, |
| Pronoun (pro.) | Person (per.), object (obj.), demonstrative (demo.), . . . |
| Preposition (pre.) | Time reference, place reference, . . . |
| Article inflection | Strong (s.), mixed (g.), weak (s.) |
| Case | Nominative (nom.), accusative (acc.), dative (dat.), genitive (gen.) |
| Genus | Feminine (f.), masculine (m.), neuter (n.) |
| Numerus | Singular (sg.), plural (pl.) |
| Person | 1Sing, 2Sing, 3Sing, 1Plu, 2Plu, 3Plu, courtesy (2sgH.), (3plH.) . . . |

In the right column of the following table, some possible examples of grammatical categories 12 of English are given (e.g. no genus over the article, conjugation of persons only in 2 forms, etc. etc.):

TABLE 2
Examples of grammatical categories of the English language

| | |
|---|---|
| Noun (s.) | Standard, genitive (gen.), accusative (acc), dative (dat), nominative (nom), proper noun |
| | (pn.) |
| Verb (v.) | Infinitive (inf.), 3rd person (3+.), not 3rd person (3−.), past participle (pper.), present |
| | participle (ppres.), modal (mod.), future tense (fut.), past (past.), present tense (pres.), |
| | continuous (cont.) |
| Adjective (adj.) | Standard, comparative (compa.), demonstrative (dem.), possessive (poss.) |
| Article (art.) | Definite (def.), indefinite (indef.) |
| Conjunction (conj.) | Copulative (copu.), disjunctive (disj.) |
| Adverb (adv.) | Negation (neg.), time .tim, place (loc.), quantity (dim), |
| Pronoun (pro.) | Person (per.), object (obj.), demonstrative (dem.), . . . |
| Preposition (pre.) | Standard, to (.to) |

This exemplary classification of grammatical categories 12 is not conclusive. What is important is that there is a self-consistent assignment of grammatical categories 12 to individual lexical items 11 of the string 10. The guidance of the grammatical case in all languages is relevant for the precision of the analysis result and following evaluations of the result, even if this is unusual for Anglo-Saxon usage except for the genitive.

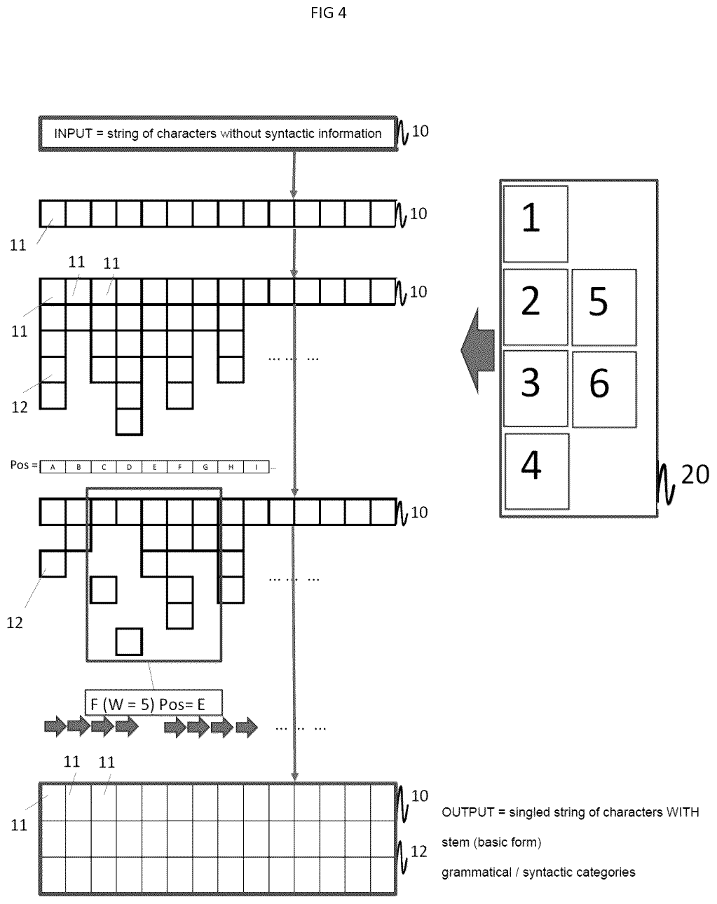

The character string 10 according to FIG. 1 has 17 syntactic entities: 15 words+2 punctuation marks. When a reading device 1 of a computer system 20 (see FIG. 4) provides such a character string 10, a dictionary device 2 of the computer system 4 decomposes the character string 10 into the individual lexical elements 11. For this purpose, the dictionary device 2, has word lists and their basic forms, which can then be determined in the character string 10. For words that allow only one basic form, all possibilities are considered. If the language is structured coherently with respect to these doublings, it also solves the presented procedure.

A syntax device 3 on the computer system 20 now determines, which possible grammatical categories 12 can be assigned to the individual lexical items 11, or their basic forms. For this purpose, the syntax device 3 accesses a database 5, which contains, for example, the information in the above tables 1 and 2.

In the case shown in FIG. 1, the first lexical item 11 “it” is assigned the grammatical categories 12 “pronoun, third person, neuter” and “pro.obj.” (object pronoun), third person neuter” are assigned. The second lexical element 11 “is” is assigned eight grammatical categories 12.

The complete list of grammatical categories 12 used in the example of FIG. 1 is given in Table 1 (bracketed expressions).

FIG. 1 also indicates in each case the number of grammatical categories 12 per syntactic element 11. For example, the auxiliary verb “are” has twelve different possible grammatical categories 12 in this string 10 (see line Σ Var per kat).

Thus, in FIG. 1, there are basically 0.165 trillion (see line Π all kat) different ways to combine the grammatical categories 12 of the string 10 when the entire length of the string 10 is analyzed, and of these, the only correct one is to be found, in a time around 1 second, on portable computers/smartphones.

In the following, it is shown how a verification device 4 of the computer system 20 is used to determine combinations of the grammatical categories 12, which at the same time automatically assigns a grammatical category to the character string 10.

For this purpose, in the embodiment described here, a frame F is used, which can consider five syntactic elements 11 at a time. This frame F is now passed over the string 10 one by one, advancing one lexical element 11 at a time. (See also Table 3)

Thus, the above combinations of grammatical categories 12 are not performed over the entire string 10, but only for the grammatical categories 12 of the lexical items 11 covered by the frame F, one at a time. The use of the frame F, which covers only a subset of the syntactic units 11, results in a very large reduction of the combination possibilities to be matched.

For example, in a frame of width 5, the centered position is always evaluated as correct or incorrect with the inclusion of “2left, 2right”. At the beginning of a sentence the position 2-li is empty; 1-li=“begin”. At the end of string 10, re-1=“end” and re-2 is empty. At the beginning and end of the sentence, 4 lexical positions are compared for their grammar/syntax patterns.

For example, if the frame F with W=5 covers the first lexical element 11 (here “it”) to the third (2 left, 2 right) lexical element 11 (here “a”), this results in 2×8×8=128 possible combination of grammatical categories 12 (see line Σ Var per kat) at “It”.

If the frame F a lexical element 11 is moved forward in the string 10 (i.e. on “is,” for example), then there are (2 left 2 right) 2×8×8×5=640 possibilities.

The number W of lexical elements 11 per frame F must of course be smaller than the total number of lexical elements 11 of the string 10. As mentioned, it is more efficient to work with Win the range 3 or 5. With frame width, the number of required comparisons increases exponentially. Normal speech is understandable for humans with fixation widths around 3 to 5, respectively it is “spoken” like this everywhere.

By using the frame F with a predetermined width W=5 of possible lexical elements 11 and so to say a “dynamic shifting” of the window from left to right, in reading direction, combinations of the next steps can already be reduced in advance in each position of F. This way, the number of necessary comparisons is reduced exponentially. Thus the actual total combination possibilities to be checked sink again very significantly.(see example 3c)

In FIG. 1, all positions of the frame “F” with width “W”=5 up to position 8 are shown in the steps of the staircase shape.

### Example 3

Combinations and processing times—t—for syntactic analysis of the sentence of FIG. 1 at a required computation time per pattern match (1 in 10,000 F/W patterns)= 1/100 sec.

See also Table 3

#Variants : t= computation time
a) maximum (theoretical) number of combinations sentence →
165,622,579,200: t = 52.2 yrs
b) theor. number of combinations by using a window F W=5 → 121,276:
t = 20.2 min
c) total combinations with all false patterns eliminated in advance
in 16 steps →1,284: t = 1.3 sec.

FIG. 2 shows the analysis of the sentence from FIG. 1 depicted at the sixth step of the processing.

Due to the reduction of possible categories by false patterns in the fields 1, 2, 3, 4 and 5 of the sliding window F with W=5 by the previous 5 calculations in the window positions before, the number of remaining variants for step 6, which still have to be calculated, is already only 108 and not 1920 as results from the full number of variants at the beginning, without using a sliding window (see FIG. 1).

The combinations of grammatical combinations to be calculated, which leads to the final number 1,284, is shown in Table 3.

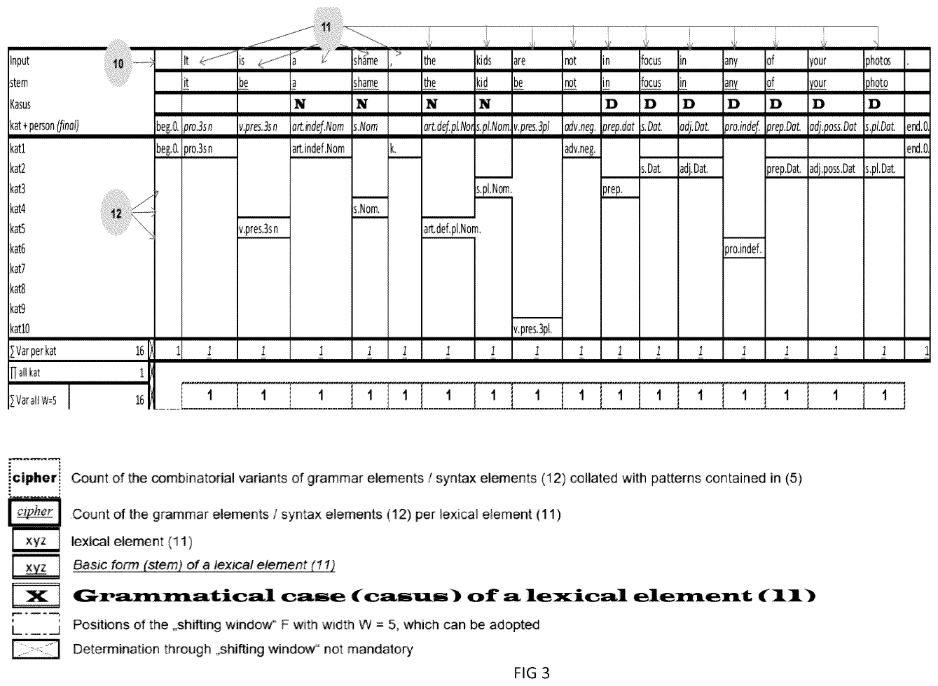

After all comparisons have been performed, a clear assignment of all grammatical categories 12 to the character string 10 results, which is shown in FIG. 3. In FIG. 4, an embodiment using the computer system 20 is shown schematically. Here, the reading in device 1 for the character string 10, the dictionary device 2, the syntax device 3, the verification device 4 and the database 5 as well as the correction and completion device 6 of a unit are arranged. In principle, it is possible that the elements/devices are distributed in whole or in part to several computers or even mobile terminals.

On the left hand side of FIG. 4, it is shown how the string 10 is gradually processed by the string 10 reading device 1, the dictionary device 2, the syntax device 3, the verification device 4, and the database 5.

The dictionary device 2 divides the character string 10 into individual syntactic elements 11. The syntax device 3 assigns at least one grammatical category 12 to each of the individual lexical elements 11. The verification device 4 then uses a frame F to capture the possible combinations of the grammatical categories 12 of the lexical elements 11, insofar as they are covered by the frame F.

The completion and correction device 6 corrects and modifies as necessary to produce correct syntactic output or, if necessary, to automatically generate notices to the user. The verification device 4 may also automatically identify, by, lexical items whose syntactic elements are suitable for purposes of summarizing or identifying action or event scenarios in context, more efficiently but not exclusively via case: who does what, to whom, with what, in whose possession, via temporal adverbs or other time-representing words: when, until when, via conjunctions and their connected clauses: why, for whom, via adverbs of quantity or numbers and their dimensions: how much, of what, via adverbs of place, proper nouns: where, who, what, with whom, special punctuation marks, such as colon, direct speech, expressions enclosed in dashes or brackets.

In the case of character strings (10) which are detected as ambiguous by the verification device (4), an interpretation and supplementation device (6) automatically generates queries as character strings (10) including the identified, remaining syntactic elements (12)—which are themselves recognized as correct by the verification device (4), in order to be able to communicate them online or offline to a user or subsequent program via visual, tactile/sensory or auditory signs or signals.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.” Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present invention have been described in detail, it should be understood that the various changes, substitutions, and alterations could be made hereto without departing from the spirit and scope of the present invention.

1. An apparatus for analyzing natural language in the form of at least one character string, comprising
a reading device of a computer system for reading and providing the at least one character string,
a dictionary device of the computer system configured to decompose the at least one character string provided by the reading device into a plurality of syntactic elements,
a syntax device of the computer system configured to assign at least one grammatical category to each lexical item, and
a verification device of the computer system, configured to automatically determine, for syntactic elements in a frame with a predetermined number of lexical elements of the at least one character string, which of the arrangements of the lexical elements in the frame is correct and which is incorrect on the basis of grammar or syntax patterns of the natural language stored in advance in a database for grammatical categories of the lexical elements,
wherein the frame is superimposable by the verification submission successively over each syntactic element of the at least one character string, wherein for each position of the frame all possible variations of the possible correct and incorrect arrangements of the lexical elements are detected by the grammar or syntax patterns,
wherein the verification device validates the at least one character string as syntactically correct and unambiguous if exactly one permitted grammatical category is determined for each lexical element; and
a correction and completion device configured to determine, in the at least one character string and grammatical categories associated with the lexical elements, systematically changes in at least one lexical element of the at least one character string, or by adding lexical elements with suitable grammatical categories, that the verification device recognizes the at least one character string, after the at least one introduced change in the at least one character string, as correct by renewed pattern matching.

2. (canceled)

3. The apparatus according to claim 1, wherein a lexical element comprises or consists of a word or a punctuation mark.

4. The apparatus according to claim 1, wherein the beginning of the at least one character string and the end of the at least one character string each represent a lexical element.

5. The apparatus according to claim 1, wherein punctuation marks each represent a lexical element.

6. The apparatus according to claim 1, wherein the verification device is further adapted to identify the frame-by-frame determined correct grammatical categories of the lexical items.

7. (canceled)

8. The apparatus according to claim 1, wherein syntactic errors in the at least one character string are detected with the verification device, a syntactic error being present if the verification device does not retain only a single grammatical category for at least one lexical element or has not determined any permitted grammatical category.

9. The apparatus according to claim 1, wherein the correctness of each lexical element is verifiable by matching each syntactic element against a dictionary of the dictionary apparatus.

10. The apparatus according to claim 1, further comprising a correction device for automatically correcting syntactic errors contained in the at least one character string.

11. A method for analyzing natural language in the form of at least one character string, the method comprising:
reading at least one character string into a computer system;
decomposing the at least one character string into several syntactic elements;
assigning at least one grammatical category to each lexical item, and
automatically analyzing, by a verification device, the lexical items in a frame having a predetermined number for the lexical items of the at least one character string on the basis of natural language grammar rules for grammatical categories of the lexical items stored in advance in a database;
determining which of the arrangements of the lexical items in the frame is correct and which is incorrect,
wherein the frame is superimposable by the verification submission successively over each syntactic element of the at least one character string, and
wherein for each position of the frame all possible variations of the possible correct and incorrect arrangements of the lexical elements are detected by the grammar or syntax patterns.

12. The method according to claim 11, wherein the syntactic elements are used for reformulations of the character string with respect to tense, numerus, genus, case, gender, and are automatically performed in such a way that the syntactic elements are recognized as correct by the verification device.

13. The method according to claim 11, further comprising a verification device automatically identifying, by the verification device, lexical items whose syntactic elements are suitable for purposes of summarizing or identifying action or event scenarios in context via case, via temporal adverbs or other time-representing words, via conjunctions and their connected clauses, via adverbs of quantity and their dimensions, via adverbs of nouns, and/or special punctuation marks.

14. The method according to claim 11, wherein, in response to character strings being detected as ambiguous automatically generating queries as character strings—including the identified, remaining syntactic elements—which are themselves recognized as correct by the verification device, in order to communicate the character strings for presentation to a user or subsequent program.

15. The method according to claim 11, further comprising assembling information available as text from an automatic speech recognition device into at least one character string, which is recognized as correct by the verification device, for use as machine-executable instructions, in any man-machine interface.

16. The method according to claim 11, further comprising combining information available as text from at least one device for automatic image processing into at least one character string, which itself is recognized as correct by the verification device (4), which can be used as executable machine instructions.

17. The method according to claim 11, further comprising, in the case of character strings which are detected as ambiguous by the verification device, automatically inserting commas in the case of blank characters of the character string until the verification device recognizes the modified character string as correct.

18. The method according to claim 11, wherein the sequence decisions causal to the computation results of the steps of the method by machine-executable instructions are deterministically documentable for traceability of a man-machine interface with respect to its input and the resulting actions in which these machine-executable instructions have been applied.

19. The method according to claim 11, wherein on the basis of formal specifications for texts, such as comprehensibility of the sentence structure (subject, predicate, object sequence) or formal logical coherence, but not exclusively, evaluations of the formal structure with respect to length, type and sequence of morphological components of the character string are carried out automatically in order to be able to communicate these online or offline to a user or subsequent program via visual, tactile/sensory or auditory signs or signals.
